(19) United States
(12) Patent Application Publication
(10) Pub. No.: US 2026/0120317 A1
(43) Pub. Date: Apr. 30, 2026

(54) SYSTEMS AND METHODS FOR IMAGE TRACKING WITH MONOCULAR IMAGERY

(71) Applicant: CoVar, LLC

(72) Inventor: Peter A. TORRIONE, Wilmington, DE (US)

(21) Appl. No.: 18/932,420

(22) Filed: Oct. 30, 2024

(51) Int. Cl. G06T 7/73; G06T 7/11; G06T 7/277; G06V 20/58

(52) U.S. Cl. CPC G06T 7/74; G06T 7/11; G06T 7/277; G06V 20/58

(57) ABSTRACT

The present embodiments provide systems and methods for tracking objects using refined bounding boxes and bounding box association. The system can include image sensors, a detector, a tracker, and a server.

### FIELD OF THE DISCLOSURE

The present disclosure relates to systems and methods for object detection and tracking using real-world coordinates.

### BACKGROUND

Target detection in monocular imagery can be solved using standard off-the-shelf deep learning models (e.g., to draw a box around a tank in an image). In many applications, it is important to not only detect the object, but also provide a unique target identifier to “track” the entity over time. Tracking in image space (e.g., pixel coordinates) is challenging because object motion does not always manifest in pixel motion in straightforward ways, and because when the camera moves, or an entity moves out of the frame, target re-acquisition is challenging. If targets could be localized in true “world coordinates” (that is GPS or LAT/LON), from monocular systems, then entities could be reliably tracked in world-space coordinates, solving many of the problems inherent to tracking in 3-Space.

Therefore, there is a need to provide systems and methods that overcome these deficiencies.

### SUMMARY OF THE DISCLOSURE

In some aspects, the techniques described herein relate to a system for tracking objects including: one or more image sensors configured to capture one or more images; a detector processor configured to: detect one or more objects from the images, generate one or more first bounding boxes around the objects, wherein each of the first bounding boxes surrounds each of the objects; and a tracking processor configured to: refine the first bounding boxes by minimizing space between each objects and the corresponding bounding boxes; estimate one or more real-world locations of the objects based on the first bounding boxes; project the real-world locations of the objects into one or more second bounding boxes; receive a new detection of the objects; associate the new detection with the second bounding boxes; update the estimation of the real-world locations of the objects; and predict, based on the updated real-world locations, one or more future real-world locations of the objects.

In some aspects, the techniques described herein relate to a method for tracking objects including: capturing, by a processor, one or more images; detecting, by the processor, one or more objects from the images; generating, by the processor, one or more first bounding boxes around the objects; refining, by the processor, the first bounding boxes; estimating, by the processor, one or more real-world locations of the objects based on the first bounding boxes; projecting, by the processor, the real-world location of the objects into one or more second bounding boxes; receiving, by the processor, a new detection of the objects; associating, by the processor, the new detection with the second bounding boxes; updating, by the processor, the estimation of the real-world location of the objects; and predicting, by the processor based on the updated location, a future location of the objects.

In some aspects, the techniques described herein relate to a non-transitory computer readable medium containing computer executable instructions that, when executed by a device including a processor, configure the computer hardware arrangement to perform procedures including: capturing, by a processor, one or more images; detecting, by the processor, one or more objects from the images; generating, by the processor, one or more first bounding boxes around the objects; refining, by the processor, the first bounding boxes; estimating, by the processor, one or more real-world locations of the objects based on the first bounding boxes; projecting, by the processor, the real-world location of the objects into one or more second bounding boxes; receiving, by the processor, a new detection of the objects; associating, by the processor, the new detection with the second bounding boxes; updating, by the processor, the estimation of the real-world location of the objects; and predicting, by the processor based on the updated location, a future location of the objects.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates a system according to an exemplary embodiment.

FIG. 2 is a sequence diagram illustrating a process according to an exemplary embodiment.

FIG. 3 is diagram illustrating a refinement action according to an exemplary embodiment.

FIG. 4 is a diagram illustrating a projection according to an exemplary embodiment.

FIG. 5 is a diagram illustrating an association action according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The invention relates generally to systems and methods for detecting and tracking objects with monocular imaging. Monocular imagery refers to images or videos that are captured using a single camera or sensor, such as a smartphone camera, a webcam, or a drone camera. Monocular imagery can be still or moving and can include various types of visual information, such as color, texture, shape, and depth. Tracking objects, e.g. vehicles, with monocular imagery can be difficult. Because object motion does not always manifest in pixel motion in straightforward ways, and because when the camera moves, or an entity moves out of the frame, target re-acquisition is challenging.

As a solution to this problem, the present embodiments provide systems and methods for tracking objects via monocular imagery using real-world coordinates. Generally, the systems can include a camera or image capture device, a detector, and a tracker. The camera can capture one or more images as well as video of one or more objects. The detector or detector processor can detect objects in the images, e.g. a truck is moving across a road. The tracker can estimate the real world location of the truck, then project the real world location of the truck onto an image space which can be defined using one or more bounding boxes. When the tracker receives a new detection or image including the vehicle, the tracker can associate or combine the new detection with the existing bounding boxes, ensuring that the new detections are congruent with the existing bounding boxes. This limits the risk of an object becoming lost from the tracker. This also prevents the tracker from generating bounding boxes around irrelevant objects or otherwise placing bounding boxes in the incorrect areas. Once the new detection has been properly associated with existing bounding boxes, the position of the vehicle can be updated. Other information that can be updated includes without limitation position, velocity, and acceleration. Next, the system can predict the location of the vehicle prior to the next round of image processing, i.e. before the next round of projecting the real-world coordinates into image space. Thus, the systems predict where the object is going to be next, thus further ensuring that the object is being tracked appropriately and limiting any erratic or incorrect detections.

Using world coordinate-based solutions for target tracking can offer several improvements over conventional tracking and imaging systems. By tracking targets in world-space coordinates, one can obtain more accurate and precise information about the location and movement of the targets. This can help improve the accuracy of target tracking and provide more reliable information for decision making. Additionally, world coordinate-based tracking can provide a more robust solution for target tracking, especially in situations where the camera moves or the target moves out of the frame. Since the tracking is based on world coordinates, it is less affected by changes in the camera's position or orientation, or by the target moving out of the camera's field of view. World coordinate-based tracking can be easily integrated with other systems such as radar, lidar, or other sensors that provide world coordinate-based information. This can help provide a more complete picture of the situation and enable more advanced decision-making capabilities. In summation, the present embodiments offer a number of improvements over conventional systems, and they solve a technological problem in the imaging and tracking technology space.

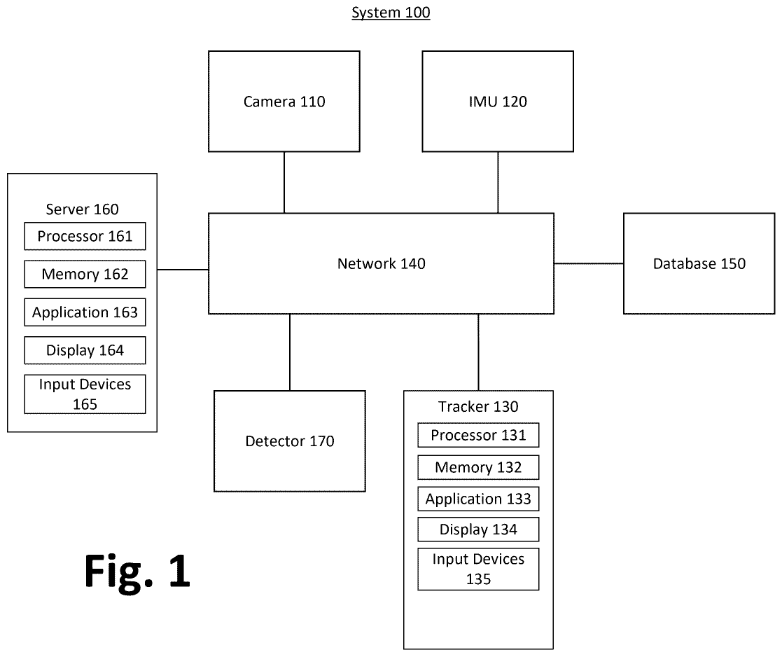

FIG. 1 is a system according to an exemplary embodiment. The system 100 can comprise a camera 110, an inertial measurement unit (IMU) 120, a tracker 130, a network 140, a database 150, a server 160, and a detector 170. Although FIG. 1 illustrates single instances of components of system 100, system 100 may include any number of components.

The camera 110 can include any monocular image capturing device. The camera 110 can include a camera sensor such as a CCD or CMOS sensor, which converts the light entering the camera lens into digital signals that can be processed by the camera's image processor. The camera can include a camera lens capable of zoom or adjusting the view of the camera for a wide range of uses and applications. The camera can further include an image processor which is the hardware component that performs various operations on the raw image data captured by the camera sensor. This can include tasks such as image enhancement, noise reduction, compression, and feature extraction. The camera can further include a memory which stores the processed image data and any other relevant data, such as metadata or image annotations. The camera can also include any control electronics which manage the camera's operation, including settings such as exposure time, aperture, and ISO sensitivity. The camera can further include any power source necessary to provide the energy needed to operate the camera.

The IMU 120 is a sensor system which can perform image detection and tracking, and it can be used to measure the linear and angular motion of an object. The IMU 120 can be connected to the camera 110. The IMU 120 can include a combination of accelerometers and gyroscopes, which measure the acceleration and rotation rates of the object, namely the camera. The IMU 120 may also include a magnetometer, which measures the magnetic field around the camera to determine its orientation with respect to the Earth's magnetic field. For example, the IMU 120 can be used in combination with the camera 110 to track the position and orientation of a drone or a robot in real-time, by fusing the measurements from the IMU and the camera using sensor fusion algorithms, such as the Kalman filter or the extended Kalman filter.

The system 100 can include a tracker 130. The tracker 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. A wearable smart device can include without limitation a smart watch.

The tracker 130 may include a processor 131, a memory 132, and an application 133. The processor 131 may be a processor, a microprocessor, or other processor, and the tracker 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the tracker 130 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as image data and image tracking data.

The application 133 may comprise one or more software applications, such as a mobile application and a web browser, comprising instructions for execution on the tracker 130. In some examples, the tracker 130may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. Such processes may be implemented in software, such as software modules, for execution by computers or other machines. The application 133 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The tracker 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the tracker 130 that is available and supported by the tracker 130, such as a touch-screen, keyboard, mouse, cursor-control device, touch-screen, microphone, digital camera, video recorder or camcorder. These devices may be used to enter information and interact with the software and other devices described herein.

The system can include one or more networks 140. In some examples, the network 140 may be one or more of a wireless network, a wired network or any combination of wireless network and wired network, and may be configured to connect the user device 110, the contactless card 120, the payment information processor 130, the database 150 and the server 160. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

The system 100 can include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 160 or may be hosted externally of the server 160, such as by a server, by a cloud-based platform, or in any storage device that is in data communication with the server 160.

The system 100 can include a server 160. The server 160 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 160 may include a processor 161, a memory 162, and an application 163. The processor 161 may be a processor, a microprocessor, or other processor, and the server 160 may include one or more of these processors. The server 160 can be onsite, offsite, standalone, networked, online, or offline.

The processor 161 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 161 may be coupled to the memory 162. The memory 162 may be a read-only memory, write-once read-multiple memory or read/write memory, e.g., RAM, ROM, and EEPROM, and the server 160 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 162 may be configured to store one or more software applications, such as the application 163, and other data, such as user's private data and financial account information.

The application 163 may comprise one or more software applications comprising instructions for execution on the server 160. In some examples, the server 160 may execute one or more applications, such as software applications, that enable, for example, network communications with one or more components of the system 100, transmit and/or receive data, and perform the functions described herein. Upon execution by the processor 161, the application 163 may provide the functions described in this specification, specifically to execute and perform the steps and functions in the process flows described below. Such processes may be implemented in software, such as software modules, for execution by computers or other machines. The application 163 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 160 may further include a display 164 and input devices 165. The display 164 may be any type of device for presenting visual information such as a computer monitor, a flat panel display, and a mobile device screen, including liquid crystal displays, light-emitting diode displays, plasma panels, and cathode ray tube displays. The input devices 165 may include any device for entering information into the payment information processor 130 that is available and supported by the payment information processor 130, such as a touch-screen, keyboard, mouse, cursor-control device, touch-screen, microphone, digital camera, video recorder or camcorder. These devices may be used to enter information and interact with the software and other devices described herein.

The system 100 can include a detector 170. The detector 170 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The detector 170 may include a processor 171, a memory 172, and an application 173. The processor 171 may be a processor, a microprocessor, or other processor, and the detector 170 may include one or more of these processors. The detector 170 can be onsite, offsite, standalone, networked, online, or offline.

The processor 171 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 171 may be coupled to the memory 172. The memory 172 may be a read-only memory, write-once read-multiple memory or read/write memory, e.g., RAM, ROM, and EEPROM, and the detector 170 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 172 may be configured to store one or more software applications, such as the application 173, and other data, such as user's private data and financial account information.

The application 173 may comprise one or more software applications comprising instructions for execution on the detector 170. In some examples, the detector 170 may execute one or more applications, such as software applications, that enable, for example, network communications with one or more components of the system 100, transmit and/or receive data, and perform the functions described herein. Upon execution by the processor 171, the application 173 may provide the functions described in this specification, specifically to execute and perform the steps and functions in the process flows described below. Such processes may be implemented in software, such as software modules, for execution by computers or other machines. The application 173 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The detector 170 may further include a display 174 and input devices 175. The display 174 may be any type of device for presenting visual information such as a computer monitor, a flat panel display, and a mobile device screen, including liquid crystal displays, light-emitting diode displays, plasma panels, and cathode ray tube displays. These devices may be used to enter information and interact with the software and other devices described herein.

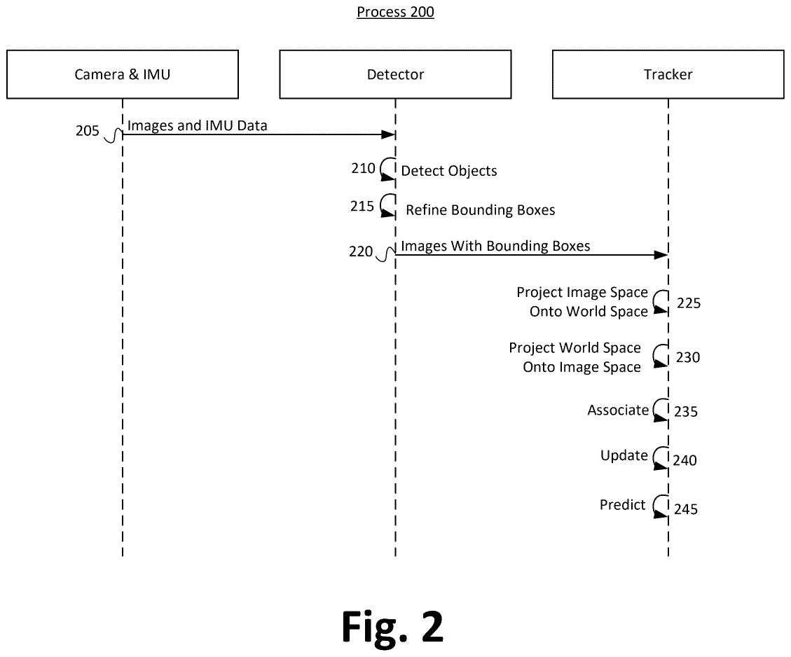

FIG. 2 is a sequence diagram illustrating a process 200. The process can include without limitation a camera, a detector, and a tracker. These elements are discussed with further reference to FIG. 1.

In action 205, the camera can capture one or more images and transmit the images to the detector. The images can include a multitude of data and information including without limitation color, texture, shape, depth, and other visual information. The camera can capture these images through photographs, multiple photographs, and video. The images can be captured continuously. The images can be transmitted from the camera to the detector one-by-one, in batches, or a continuous stream. The camera can transmit the images to the detector over a wired or wireless network discussed with further reference to FIG. 1. In some embodiments, the camera can be a stand-alone camera, and in other embodiments the camera may be attached to a vehicle, a drone, an aircraft, a watercraft, or some other moving vehicle. In some embodiments, the camera and the detector can be operably connected in the same device or client. In some embodiments, the camera can also send the images to a database or data storage unit discussed with further reference to FIG. 1. In still other embodiments, the camera can transmit the images to a server which can in turn send the images to the detector and tracker. The server is discussed with further reference to FIG. 1. The camera can be remotely operated by a human user or by some automatic process initiated by a computer, machine, or algorithm. For example, the camera can be configured with a motion tracking processor or algorithm that moves that camera to view one or more moving objects.

The camera can generate or capture and transmit one or more images, including without limitation infrared (IR) images. In the present embodiments, IR images can be used to enhance the detection and recognition of objects, especially in low-light or adverse weather conditions where visible light may be limited or distorted. Further, the IR images can be used to detect people or animals in low-light conditions, or to detect hot spots or thermal anomalies in buildings or equipment. The IMU can transmit 6DOF data, or 6 degrees of freedom. 6DOF describes the full motion and orientation of an object in 3D space according to the position of the camera. The six degrees of freedom are: three translational degrees of freedom referring to the movement of the object along the x, y, and z axes of a 3D coordinate system; three rotational degrees of freedom referring to the orientation of the object around the x, y, and z axes of a 3D coordinate system. The IMU can estimate the 6DOF parameters of an object by measuring its linear and angular acceleration using accelerometers and gyroscopes, respectively. The IMU can then integrate these measurements over time to estimate the object's velocity, position, and orientation.

Upon receiving the images and/or 6DOF data from the camera, the detector in action 210 can detect one or more objects within the one or more images. As a nonlimiting example, the detector can detect a vehicle. The action of detecting one or more images can be accomplished without limitation through one or more motion detection or object detection algorithms. As a nonlimiting example, the object detection algorithms can enable the detector or detector processor to divide an image into smaller regions, called proposals or regions of interest (RoIs), and then classify each proposal as either containing an object of interest or not, and then predicting the bounding box that tightly encloses the object. A bounding box is a rectangular box that encloses an object or region of interest in an image. The bounding box is usually defined by its position, width, and height, and can be used to localize and track objects in an image or video sequence. For example, a bounding box can enclose a vehicle moving across a landscape, and the bounding box can track with the vehicle as the vehicle moves. Once the bounding boxes are generated, they can be used to extract the image patches corresponding to the detected objects, and to perform further analysis and processing, such as feature extraction, classification, or segmentation. The bounding boxes can also be used to track the objects over time, by matching the boxes in consecutive frames of the video sequence.

Furthermore, the bounding boxes can be segmented. Bounding box segmentation is a technique in computer vision and image processing that involves drawing a rectangular box (known as a bounding box) around an object of interest in an image or video frame. The goal of bounding box segmentation is to locate the object within the image or video frame and provide a spatial context for subsequent analysis or processing. To create a bounding box, an algorithm is used to identify the location of an object of interest within an image or video frame, and then draw a rectangle around the object such that it encompasses the entire object.

In some embodiments, the image is first divided into many smaller regions, each of which may contain objects of interest. This can be done using a region proposal algorithm, such as Selective Search or Edge Boxes. For each region, a set of features are extracted from the image. Typically, deep convolutional neural networks (CNNs) are used to extract these features, which can capture important visual patterns and features, such as edges, corners, and texture. Each region is then classified as containing an object of interest or not, using a classifier such as a Support Vector Machine (SVM) or a neural network. If a region is classified as containing an object, the algorithm predicts the bounding box that tightly encloses the object. This is done using a regression model that predicts the offsets from the proposal region to the actual object bounding box. Since some proposals may overlap or contain the same object, a non-maximum suppression step is used to remove redundant detections and keep only the most confident ones. The final output of the object detection algorithm is a set of bounding boxes and their corresponding class labels, indicating the locations and identities of the objects in the image.

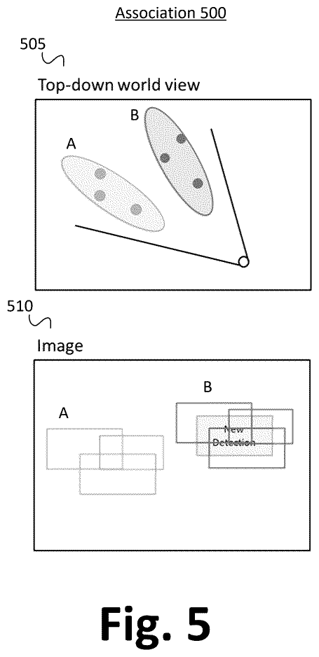

Having detected the objects and generated one or more first bounding boxes, the detector in action 215 can refine the bounding boxes by comparing the object within a certain bounding box with one or more reference images including without limitation known images, design, blueprints, models, CAD models, and other references for generating more accurate bounding boxes. Using these reference images, the refining action can draw a more accurate bounding box around the object. For example, the refining action can limit the empty space between the bounding box and the detected object. The refinement action is discussed with further reference to FIG. 5.

In action 220, the detector can transmit the images with bounding boxes and/or refined bounding boxes to the tracker. The images can be transmitted over a wireless or wired network. The images can be transmitted individually, in groups, or continuously in a stream of data. In some embodiments, the images can be compressed before being sent, then decompressed upon receipt at the tracker. In some embodiments, the tracker may be associated with a server including a cloud server. In other embodiments, the tracker may operate independently of a server yet still employ the server for processing. Having received the images with bounding boxes, the tracker in action 225 can project the images from image space onto world space. For example, the tracker can estimate the dimensions of the object using for example pixels and FOV. Furthermore, the tracker can estimate the location of the entity in world-space coordinates using the known camera location and pointing angle. With the known or estimate dimensions of the target and knowledge of the camera intrinsics and extrinsics, the range and bearing of the object can be calculated. For example, once the camera is calibrated, the image of the vehicle can be processed to estimate its real world location. This typically involves detecting the vehicle in the image using object detection techniques (such as YOLO or Faster R-CNN), and then using the height of the vehicle (which is known in pixels) and the camera's intrinsics and extrinsics to estimate the distance between the camera and the vehicle. In image detection, camera intrinsics and extrinsics are parameters that describe the geometric properties of a camera and its position and orientation in the 3D world, respectively.

Camera intrinsics refer to the internal parameters of the camera, which are fixed and remain the same regardless of the camera's position or orientation. These parameters include the focal length of the lens, the position of the principal point (the point where the optical axis intersects the image plane), and the distortion coefficients that correct for lens distortions. Camera extrinsics, on the other hand, refer to the external parameters of the camera, which describe its position and orientation in the 3D world. These parameters include the translation vector (the position of the camera center relative to the 3D world coordinate system) and the rotation matrix (the orientation of the camera relative to the 3D world coordinate system).

In some embodiments, triangulation can be used to estimate the real world coordinates of the vehicle. Triangulation is based on the principle of using multiple perspectives to determine the 3D location of a point in space. In the case of a camera, each perspective corresponds to an image captured from a different location and orientation. To use triangulation to estimate the real world coordinates of a vehicle, the camera can capture at least two images of the vehicle from different locations and orientations. In some embodiments, the images may have some overlap, so that the position of the vehicle in each image can be matched. Once two or more images of the vehicle have been captures, feature detection and matching algorithms (such as SIFT or SURF) can identify common points in each image. These points are then used to compute the epipolar geometry, which describes the relationship between the two camera perspectives. Generally, the position of the vehicle can the be triangulated in three dimensional space. This involves finding the intersection point of two or more lines of sight, each originating from a different camera perspective and passing through the corresponding feature point in the image.

Although reference has been made to vehicles, it is understood that other objects can be similarly tracked. These objects can include without limitation: one or more human beings, including crowds for crow-monitoring and security surveillance; other vehicles such as a cars, motorcycles, bicycles, golf carts, four-wheelers, snow mobiles, helicopters, planes, and other vehicles; wildlife; drones including unmanned aerial vehicles (UAVs); and industrial equipment such as machinery.

Next, the tracker in action 230 can project world coordinates onto image space coordinates which requires mapping targets that are already tracked and represented in world-space back into image space. Each target is represented as a density in world-space coordinates; in order to represent these tracked objects back in image space, we sample locations from this density (with the known estimated target height) and project them back into the image coordinates (e.g., bounding boxes).

Next, the tracker in action 235 can associate the new detections with previous detections so that the object is tracked correctly. New detection can refer to frames or images received by the tracker. Based on the largest average overlap between those projected bounding boxes, we associated the new detection with the that largest overlap. For example, if the tracker has generated three bounding boxes across three detections of the object, the tracker would calculate or determine an area that contains the most of each of the three boxes. This ensures that the new detection is placed within the average of the previous tracking, moreover, ensuring that the new detection is not misplaced too far away from the previous measurements. The largest average overlap can be calculated by the tracker processor or some associated processor such as a server. In other embodiments, the association step can additionally include a determination of the largest overlap with added emphasis on the most recent bounding box, ensuring that the subsequent calculation of the largest overlapping area can, at least in some circumstances, be affected by whichever bounding box was most recently calculated or generated.

In conventional systems, one would have to continuously track a vehicle through world space. But with each “new” detection, e.g. with each frame of detection or each time-step, conventional trackers may misinterpret where to put the new detection in terms of the previous bounding boxes. For example, a new detection might be placed too far ahead or too far behind the real world vehicle, resulting in an incorrect tracking. To solve this, the association action as explained will easily integrate new detections into existing tracking. In some scenarios, multiple targets may be tracked, and therefore many bounding boxes will have to be averaged. In such scenarios, Hungarian algorithms may be used. In object detection, after a set of objects are detected in an image or video frame, the task is to associate each detection with a ground-truth object or track. The Hungarian algorithm provides a way to find the best possible matching between detections and ground-truth objects, based on a similarity metric.

In action 240, the tracker can update the estimated positions, velocities, accelerations, and other relevant uncertainties of these objects are updated using Kalman filtering (or an appropriate tracking algorithm, e.g., extended Kalman filters and particle filters). For example, the tracker can update the position of the object relative to the most recent processing, most recent association, or most recent projection (in image space or world space) of the object. This updating action ensures that the relevant location, speed, and acceleration are being updated in a very rapid or even continuous manner. Kalman filtering can help reduce any noisy measurement or uncertain dynamics associated with tracking the object using a camera. The Kalman filter is a recursive algorithm that can handle non-linear and non-Gaussian systems by using a linear approximation and updating the filter in real-time. Kalman filtering provides a way to estimate the state of the object by combining a prediction model of the object's dynamics with the measurements received from the sensors. The filter can at least use a model of the object's dynamics to predict the state of the object at the next time step, based on the current state and any known control inputs or external disturbances. The filter can then combine the predicted state with the measurements received from the sensors to estimate the current state of the object. This is done by comparing the predicted measurements with the actual measurements, and adjusting the predicted state accordingly. The filter can then be updated by computing the new state estimate and covariance matrix, which captures the uncertainty in the state estimate. These steps may be repeated any number of times to reach a sufficiently accurate tracking of the object.

In action 245, the tracker can project the locations of the tracked objects forward in time prior to the next projection from world space onto image space but prior to the next declaration.

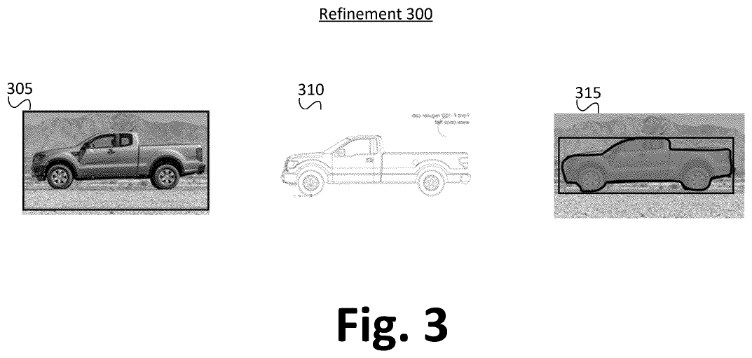

FIG. 3 illustrates a refinement process 300. The process 300 includes an image of an object, such as a vehicle. Although reference has been made to vehicles, it is understood that other objects can be similarly tracked. These objects can include without limitation: one or more human beings, including crowds for crow-monitoring and security surveillance; other vehicles such as a cars, motorcycles, bicycles, golf carts, four-wheelers, snow mobiles, helicopters, planes, other vehicles, wildlife, drones including unmanned aerial vehicles (UAVs), and industrial equipment such as machinery. In the process 300, a bounding box has been drawn or generated around a vehicle in 305. As illustrated, the bounding box has a significant amount of empty space between it and the dimensions of the vehicle. Thus, the bounding box must be refined. In addition to using real time estimation of the real world vehicle, the detector can refine the bounding box from 305 using a model 310 of the vehicle. The model 310 can include one or more reference images including without limitation known images, design, blueprints, models, CAD models, and other references for generating more accurate bounding boxes. Using these reference images, the refining action can draw a more accurate bounding box around the object in 315, thereby reducing the amount of empty space, white space, or otherwise irrelevant space between the bounding box and the vehicle.

In some embodiments, the detector can be preloaded with one or more reference images. For example, if the user desires to track a specific type of vehicle, the detector can be preloaded with reference images of those vehicles ahead of time. In other embodiments, the detector may be further configured to transmit in real time, based on the images received from the camera, a request to retrieve a reference image for a vehicle. For example, the detector may observe that a vehicle is of a certain make or model, e.g. a pickup truck versus a sedan. Upon such an observation, the detector can request a reference image related to the observation.

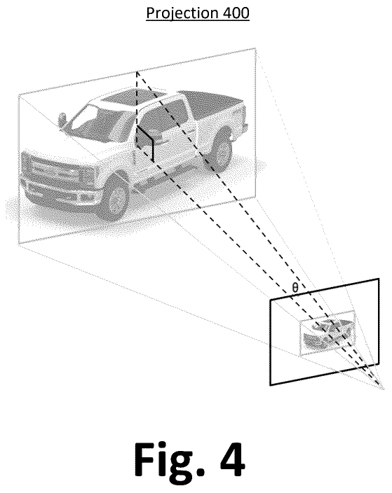

FIG. 4 illustrates a projection 400. The projection 400 can include projecting the image coordinates onto real world coordinates. Image coordinates can include height and dimensions of the object as described in pixels or image-related dimensions. With these image coordinates, the tracker can estimate the objects range and location in terms of real-world coordinates. For example, the tracker can determine that the image is one hundred pixels tall and three hundred pixels wide. Based on these dimensions, the targets real world size and location can be estimated, e.g. the object is six feet tall and two hundred meters away from the camera. Furthermore, the camera can estimate the object's range and estimate the location of the object in world-space coordinates using the known camera location and pointing angle. In some embodiments, triangulation can be used to estimate the real world coordinates of the vehicle. Triangulation is based on the principle of using multiple perspectives to determine the 3D location of a point in space. In the case of a camera, each perspective corresponds to an image captured from a different location and orientation. To use triangulation to estimate the real world coordinates of a vehicle, the camera can capture at least two images of the vehicle from different locations and orientations. In some embodiments, the images may have some overlap, so that the position of the vehicle in each image can be matched. Once two or more images of the vehicle have been captures, feature detection and matching algorithms (such as SIFT or SURF) can identify common points in each image. These points are then used to compute the epipolar geometry, which describes the relationship between the two camera perspectives. Generally, the position of the vehicle can the be triangulated in three dimensional space. This involves finding the intersection point of two or more lines of sight, each originating from a different camera perspective and passing through the corresponding feature point in the image.

Although reference has been made to vehicles, it is understood that other objects can be similarly tracked. These objects can include without limitation: one or more human beings, including crowds for crow-monitoring and security surveillance; other vehicles such as a cars, motorcycles, bicycles, golf carts, four-wheelers, snow mobiles, helicopters, planes, and other vehicles; wildlife; drones including unmanned aerial vehicles (UAVs); and industrial equipment such machinery. In some embodiments, multiple objects may be projected in real time.

FIG. 5 illustrates association 500. To maximize the accuracy of motion tracking, the present embodiments can perform track association in image space. This requires mapping the objects that have already been projected from image space onto world space to be then projected back from world space onto image space. For example, groups A and B represent in world space in action 505. Each dot—e.g. three dots in group A and three dots in group B—represent a real world coordinate associated with an object. For example, across three time-steps or image detections, two objects may be tracked by the camera. The group A illustrates where the first object was located in terms of real world coordinates across three time steps. And Group B illustrates where the second object was located across three time steps. Each of these dots, i.e. each of these locations, was estimated by projecting image space coordinates (discussed with further reference to FIG. 4) onto world space coordinates. To associate a new detection or new image from the next time-step, the tracker in 510 can project the image coordinates from 505 back into image space coordinates represented as boxes. For example, group B is now represented as three boxes. The tracker then calculates or determine an area that contains the most of each of the three boxes. This ensures that the new detection is placed within the average of the previous tracking, moreover, ensuring that the new detection is not misplaced too far away from the previous measurements. The largest average overlap can be calculated by the tracker processor or some associated processor such as a server. In other embodiments, the association step can additionally include a determination of the largest overlap with added emphasis on the most recent bounding box, ensuring that the subsequent calculation of the largest overlapping area can, at least in some circumstances, be affected by whichever bounding box was most recently calculated or generated. In other embodiments, any number of boxes may be averaged across any number of objects across any number of time-steps or image detections.

In some aspects, the techniques described herein relate to a system for tracking objects including: one or more image sensors configured to capture one or more images; a detector processor configured to: detect one or more objects from the images, generate one or more first bounding boxes around the objects, wherein each of the first bounding boxes surrounds each of the objects; and a tracking processor configured to: refine the first bounding boxes by minimizing space between each objects and the corresponding bounding boxes; estimate one or more real-world locations of the objects based on the first bounding boxes; project the real-world locations of the objects into one or more second bounding boxes; receive a new detection of the objects; associate the new detection with the second bounding boxes; update the estimation of the real-world locations of the objects; and predict, based on the updated real-world locations, one or more future real-world locations of the objects.

In some aspects, the techniques described herein relate to a system, wherein one or more objects include at least one or more vehicles.

In some aspects, the techniques described herein relate to a system, wherein the refinement further includes segmenting the first bounding boxes.

In some aspects, the techniques described herein relate to a system, wherein the refinement further includes segmenting the first bounding boxes by matching the segmentation to a reference image of the one or more objects.

In some aspects, the techniques described herein relate to a system, wherein the reference image includes at least one selected from the group of a blueprint, model, or computer-aided design (CAD).

In some aspects, the techniques described herein relate to a system, wherein the one or more image sensors are monocular imaging devices configured for ground-to-ground applications.

In some aspects, the techniques described herein relate to a system, wherein the estimation of the real-world locations of the objects is further based on at least a height of the bounding boxes, a location of the camera, and a pointing angle of the camera.

In some aspects, the techniques described herein relate to a system, wherein the projection the real-world locations of the objects into one or more second bounding boxes further includes: tracking the objects across multiple locations across a predetermined time period, sampling the locations, and projecting the sampled locations into one or more image coordinates.

In some aspects, the techniques described herein relate to a system, wherein the association of the new detection with the second bounding boxes further includes associating the new detection with a largest average bounding box overlap among the second bounding boxes.

In some aspects, the techniques described herein relate to a system, wherein the one or more images sensors include a monocular camera and an inertial measurement unit (IMU).

In some aspects, the techniques described herein relate to a system, wherein the monocular camera and IMU are associated with a standalone camera, a drone, or a moving vehicle.

In some aspects, the techniques described herein relate to a method for tracking objects including: capturing, by a processor, one or more images; detecting, by the processor, one or more objects from the images; generating, by the processor, one or more first bounding boxes around the objects; refining, by the processor, the first bounding boxes; estimating, by the processor, one or more real-world locations of the objects based on the first bounding boxes; projecting, by the processor, the real-world location of the objects into one or more second bounding boxes; receiving, by the processor, a new detection of the objects; associating, by the processor, the new detection with the second bounding boxes; updating, by the processor, the estimation of the real-world location of the objects; and predicting, by the processor based on the updated location, a future location of the objects.

In some aspects, the techniques described herein relate to a method, wherein the updating of the estimation of the real-world location of the objects is achieved through Kalman filtering.

In some aspects, the techniques described herein relate to a method, wherein the predicting of the future location is achieved through at least one selected from the group of a motion model, a Kalman filter, or a particle filter.

In some aspects, the techniques described herein relate to a method, wherein the estimation of the real-world location of the one or more objects is represented as at least one selected from the group of a global positioning system (GPS), a latitude and longitude unit, or a measurement from a position of the image sensors.

In some aspects, the techniques described herein relate to a method, wherein the refinement further includes segmenting the first bounding boxes by matching the segmentation to a reference image of the one or more objects.

In some aspects, the techniques described herein relate to a method, wherein the projection the real-world locations of the objects into one or more second bounding boxes further includes: tracking the objects across multiple locations across a predetermined time period, sampling the locations, and projecting the sampled locations into one or more image coordinates.

In some aspects, the techniques described herein relate to a method, wherein association of the new detection with the second bounding boxes further includes associating the new detection with a largest average bounding box overlap among the second bounding boxes.

In some aspects, the techniques described herein relate to a method, wherein the refinement step further includes segmenting the first bounding boxes.

In some aspects, the techniques described herein relate to a non-transitory computer readable medium containing computer executable instructions that, when executed by a device including a processor, configure the computer hardware arrangement to perform procedures including: capturing, by a processor, one or more images; detecting, by the processor, one or more objects from the images; generating, by the processor, one or more first bounding boxes around the objects; refining, by the processor, the first bounding boxes; estimating, by the processor, one or more real-world locations of the objects based on the first bounding boxes; projecting, by the processor, the real-world location of the objects into one or more second bounding boxes; receiving, by the processor, a new detection of the objects; associating, by the processor, the new detection with the second bounding boxes; updating, by the processor, the estimation of the real-world location of the objects; and predicting, by the processor based on the updated location, a future location of the objects.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language).

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

In the invention, various embodiments make reference to next images, next detections, next data, or next information as processed by the systems and methods described. It is understood that in the context of these embodiments, any reference to next images, etc. can be understood as referring to a next time-step. In the context of motion tracking, a “time-step” refers to the discrete intervals or time increments at which motion data is captured or recorded. It represents the temporal resolution or frequency at which the positions or movements of tracked objects or subjects are sampled. Motion tracking systems typically measure the position, orientation, or other kinematic parameters of objects or subjects in real-time. To capture the dynamic motion accurately, the tracking system needs to update or sample the position data at regular intervals. These intervals are defined by the time-step. A smaller time-step or shorter time interval between samples provides a higher temporal resolution, allowing for more precise tracking of fast or subtle movements. However, a smaller time-step also increases the amount of data generated, potentially requiring more processing power and storage capacity. Conversely, a larger time-step or longer time interval between samples reduces the temporal resolution but decreases the amount of data generated. This can be useful in situations where the motion being tracked is relatively slow or when there are constraints on processing power or storage resources. It is understood that the time-steps may remain constant throughout the systems and methods described herein. In other embodiments, the time-steps may be dynamically changed or adjusted by the tracker according to the needs and limits of the associated processors and servers responsible for tracking the objects.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output.

Method steps also may be performed by, and an apparatus may be implemented as, special purpose logic circuitry, e.g., an FPGA (field programmable gate array) or an ASIC (application specific integrated circuit).

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A system for tracking objects comprising:
one or more image sensors configured to capture one or more images;
a detector processor configured to:
detect one or more objects from the images,
generate one or more first bounding boxes around the objects, wherein each of the first bounding boxes surrounds each of the objects; and
a tracking processor configured to:
refine the first bounding boxes by minimizing space between each objects and the corresponding bounding boxes;
estimate one or more real-world locations of the objects based on the first bounding boxes;
project the real-world locations of the objects into one or more second bounding boxes;
receive a new detection of the objects;
associate the new detection with the second bounding boxes;
update the estimation of the real-world locations of the objects; and
predict, based on the updated real-world locations, one or more future real-world locations of the objects.

2. The system of claim 1, wherein one or more objects comprise at least one or more vehicles.

3. The system of claim 1, wherein the refinement further comprises segmenting the first bounding boxes.

4. The system of claim 3, wherein the refinement further comprises segmenting the first bounding boxes by matching the segmentation to a reference image of the one or more objects.

5. The system of claim 4, wherein the reference image comprises at least one selected from the group of a blueprint, model, or computer-aided design (CAD).

6. The system of claim 1, wherein the one or more image sensors are monocular imaging devices configured for ground-to-ground applications.

7. The system of claim 1, wherein the estimation of the real-world locations of the objects is further based on at least a height of the bounding boxes, a location of the camera, and a pointing angle of the camera.

8. The system of claim 1, wherein the projection the real-world locations of the objects into one or more second bounding boxes further comprises:
tracking the objects across multiple locations across a predetermined time period,
sampling the locations, and
projecting the sampled locations into one or more image coordinates.

9. The system of claim 1, wherein the association of the new detection with the second bounding boxes further comprises associating the new detection with a largest average bounding box overlap among the second bounding boxes.

10. The system of claim 1, wherein the one or more images sensors comprise a monocular camera and an inertial measurement unit (IMU).

11. The system of claim 10, wherein the monocular camera and IMU are associated with a standalone camera, a drone, or a moving vehicle.

12. A method for tracking objects comprising:
capturing, by a processor, one or more images;
detecting, by the processor, one or more objects from the images;
generating, by the processor, one or more first bounding boxes around the objects;
refining, by the processor, the first bounding boxes;
estimating, by the processor, one or more real-world locations of the objects based on the first bounding boxes;
projecting, by the processor, the real-world location of the objects into one or more second bounding boxes;
receiving, by the processor, a new detection of the objects;
associating, by the processor, the new detection with the second bounding boxes;
updating, by the processor, the estimation of the real-world location of the objects; and
predicting, by the processor based on the updated location, a future location of the objects.

13. The method of claim 12, wherein the updating of the estimation of the real-world location of the objects is achieved through Kalman filtering.

14. The method of claim 12, wherein the predicting of the future location is achieved through at least one selected from the group of a motion model, a Kalman filter, or a particle filter.

15. The method of claim 12, wherein the estimation of the real-world location of the one or more objects is represented as at least one selected from the group of a global positioning system (GPS), a latitude and longitude unit, or a measurement from a position of the image sensors.

16. The method of claim 12, wherein the refinement further comprises segmenting the first bounding boxes by matching the segmentation to a reference image of the one or more objects.

17. The method of claim 12, wherein the projection the real-world locations of the objects into one or more second bounding boxes further comprises:
tracking the objects across multiple locations across a predetermined time period,
sampling the locations, and
projecting the sampled locations into one or more image coordinates.

18. The method of claim 12, wherein association of the new detection with the second bounding boxes further comprises associating the new detection with a largest average bounding box overlap among the second bounding boxes.

19. The method of claim 12, wherein the refinement step further comprises segmenting the first bounding boxes.

20. A non-transitory computer readable medium containing computer executable instructions that, when executed by a device comprising a processor, configure the computer hardware arrangement to perform procedures comprising:
capturing, by a processor, one or more images;
detecting, by the processor, one or more objects from the images;
generating, by the processor, one or more first bounding boxes around the objects;
refining, by the processor, the first bounding boxes;
estimating, by the processor, one or more real-world locations of the objects based on the first bounding boxes;
projecting, by the processor, the real-world location of the objects into one or more second bounding boxes;
receiving, by the processor, a new detection of the objects;
associating, by the processor, the new detection with the second bounding boxes;
updating, by the processor, the estimation of the real-world location of the objects; and
predicting, by the processor based on the updated location, a future location of the objects.
